(19) United States
(12) Patent Application Publication
(10) Pub. No.: US 2006/0074928 A1
(43) Pub. Date: Apr. 6, 2006

(54) Selection based container listing

(75) Inventors: Matthew B. MacLaurin, Woodinville, WA (US); Andrzej Turski, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/951,374

(22) Filed: Sep. 28, 2004

(51) Int. Cl. G06F 17/30

(52) U.S. Cl. 707/100

(57) ABSTRACT

A file system user interface (UI) which facilitates selecting groups of files and automatically persisting the selection to a data store is provided. A UI preview pane can provide a dynamic list preview as the items are selected. More particularly, as the user builds a multiple selection of files, the dynamic list preview pane can display a visual depiction (e.g., stack). As the user selects each additional document, the stack grows taller and can show, as its top page, a representation of the most-recently selected document. At any point, the user can click on the list preview and the system will create a new collection object that holds or refers to all the selected items. This collection can be automatically persisted into the local store and given a default name that the user can later change.

### CROSS-REFERENCE TO RELATED APPLICATIONS

This application is related to pending U.S. patent application Ser. No. ______ entitled “Interaction of Static and Dynamic Data Sets” filed on ______, the entirety of which is incorporated by reference herein.

### TECHNICAL FIELD

This invention is related to computer systems and more particularly to a system and method to efficiently and comprehensively organize and/or create collections of files or other types of data retained within a data store or file system.

### BACKGROUND OF THE INVENTION

With technological advances in computing systems and more particularly in organization of data related to file management systems, there is an ongoing and increasing need to implement user-friendly and comprehensive mechanisms to dynamically manage selection of items within a file system or data store. Moreover, there is an ongoing and increasing need for new and innovative techniques for creating containers (e.g., lists, folders, queries) of files and other types of data within an operating system environment. Moreover, a need exists to create techniques that can be easily and quickly accessed by non-technical users in order to increase performance and efficiency of existing operating systems.

The process of creating a large selection of items can be, in user interface terms, laborious and error prone. With respect to traditional desktop user interfaces (UIs), a user can create a set of items by holding down either “shift” or “control” keys while selecting (e.g., pressing or clicking a mouse button or keyboard button) to select each item, one at a time. Unfortunately, an accidental click on a background of a window can clear the selection, thereby necessitating restart of the entire process. An additional drawback is that once selection is complete, it is not possible to directly translate this selection into a persistent collection, either explicitly or automatically. In other words, there is no automatic or even convenient technique to retain or transfer the data set onto a storage medium.

Another technique to create a collection is to manually generate a folder. This method generally requires a user to determine a location within a data store to place the folder. Next, the folder must be created and named. Accordingly, the windows on the screen must be arranged so that the folder and the items of interest are visible. Finally, the items must be dragged from other windows to the new folder. This technique requires that users plan the creation of a persistent collection, and is inappropriate when the user has already selected the desired items.

In accordance with yet another alternative method, a special item property (or property value) can be assigned to all the items belonging to a collection (e.g., folder). Then, the collection content can be found by querying for that property value. In accordance with this method, the property can be set on the items one at a time and without moving the items to a different location. An example of this technique may be tagging some pictures as favorites, or marking mail items for follow-up. However, setting the property value represents modification of the item, which is not always desirable and may even not be possible (e.g., if the item is read-only, or stored on a read-only media).

In these conventional methodologies described above, it will be understood and appreciated that “folder” organizational techniques are typically based upon a tree or hierarchical format. Recent developments in computing systems have been directed toward another type of container, the “list.” Specifically, the “list” (e.g., association container) innovation is described in the aforementioned Related Application entitled: Interaction of Static and Dynamic Data Sets. The “list”, as described in the related patent application, can include a collection of document identifiers (e.g., links, hyperlinks) together with association data that defines a location of a document within a network or system. In other words, a list can create a specification without actually moving bits of data.

Accordingly, a single document can be included within multiple lists or collections without consuming additional valuable memory space. Earlier systems required that, in order for a document to be retained in multiple folders, either duplicate versions of the document would have to be stored—one within each folder—or the user would have to manage specialized “shortcut,” “symbolic link,” objects. Lists, on the other hand, provide the linking mechanism implicitly in lieu of storing an actual copy of the document or data element. Users never need to understand the distinction between a “shortcut” and “the real document.”

In addition to the need to streamline the creation of comprehensive containers (e.g., lists), the advances in hardware and systems technologies support a need to further enhance the connectivity of computers (e.g., data stores) with respect to peripheral devices. For example, wireless networks have become increasingly popular in the home and office space. As computers continue to become an information hub in almost every home, there is a substantial unmet need to store data in a single location and to permit access to the information via remote devices (e.g., television systems, kitchen appliances, etc.).

Although recently developed systems provide limited capability to create containers (e.g., lists), there is a substantial unmet need to provide a system and/or methodology that allows a user to create and automatically persist containers that dynamically access contents of a data store.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention disclosed and claimed herein, in various aspects thereof, is directed to a file system user interface (UI) which facilitates selecting groups of files and displaying the selection via a UI preview pane. The UI preview pane can provide a dynamic list preview as the items are selected. More particularly, as a user builds a multiple selection of files, the dynamic list preview pane can display a visual depiction (e.g., stack of documents). The preview pane can be a visual region within the main window whereby a dynamic list preview is presented to the user. As the user selects each additional document, the stack grows taller and can show as its top page a representation of the most-recently selected document.

At any suitable point, the user can select the list preview and the system of the subject invention can automatically create a new collection object (e.g., container) representing the selected items. This collection object can be automatically persisted into a local store and provided a default name that the user can later change. In addition to clicking, the user can perform other operations on the list preview which can cause it to be automatically persisted. For example, the user can drag the list preview into an existing list or folder whereby the list will be created and added to the target container.

A system in accordance with an aspect of the invention facilitates creating a data container. The system includes a selection component that facilitates compiling a collection (e.g., stack) associated with one or more data components. It will be appreciated that the one or more data components can include, but are not intended to be limited to, an electronic file (e.g., word processing, text, image, audio), link, container, or combination thereof. The system can further include a container generation component that automatically generates a container that represents the collection (e.g., stack). It will be appreciated that another component or a user can prompt (e.g., trigger) the container generation component to generate and persist the container. Moreover, a preview component can be provided that dynamically displays the collection as each of the one or more data components are compiled. As described infra, the preview component can dynamically display the collection (e.g., stack) as it is compiled.

In an alternative aspect, the system can further include a rule engine component that automatically instantiates a rule to implement a predefined criteria. Additionally, a rule evaluation component can be provided that applies the rule with respect to one or more data components. Effectively, the rule-based components can instruct the selection component to select the one or more data components. In another aspect, the rule-based components can effect container generation and/or persistence onto a disk or other memory device. It will be appreciated that the rule-based components can be remotely located.

In another alternate aspect, the system can, through an analysis component, identify commonalities of the elements contained in the list and create a set definition object which is capable of identifying and collecting further items that may belong in the set.

In yet another alternate aspect, the system can employ an artificial intelligence component that predicts a user intention as a function of historical or other (e.g., statistical, extrinsic . . . ) criteria. More particularly, the artificial intelligence component can include an inference component that facilitates automatic selection of the one or more data components as a function of inferred user intention with respect to a characteristic of the one or more data components. The inference component can employ, for example, a utility-based analyses in performing the automatic selection. Moreover, the intelligence component can employ a probabilistic or statistical-based analysis to infer an action (e.g., selection, generation) that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a general component block diagram of a system for generating a container in accordance with an aspect of the subject invention.

FIG. 2 illustrates an exemplary flow chart of procedures to create a collection and generate a container in accordance with a disclosed aspect.

FIG. 3 illustrates a graphical user interface (GUI) that exemplifies the creation of a collection in accordance with an aspect of the invention.

FIG. 4 illustrates a GUI that exemplifies a collection preview which emphasizes a selected component in accordance with an exemplary aspect.

FIG. 5 illustrates a GUI that exemplifies a collection preview which emphasizes a selected component in accordance with an exemplary aspect.

FIG. 6 illustrates a UI that exemplifies a selection halo which facilitates document manipulation in accordance with a disclosed aspect.

FIG. 7 illustrates a network architectural diagram that exemplifies rule-based decision mechanisms in accordance with an alternate aspect of the subject invention.

FIG. 8 illustrates a network architectural diagram that exemplifies artificial intelligence-based mechanisms in accordance with an alternate aspect of the subject invention.

FIG. 9 illustrates a network architectural diagram of an exemplary computing environment in accordance with an aspect.

FIG. 10 illustrates a block diagram of a computer operable to execute the disclosed architecture.

FIG. 11 illustrates a schematic block diagram of an exemplary computing environment in accordance with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention can be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In accordance with aspects of the subject invention, a container (e.g., list, folder, query) can be automatically generated and persisted by a user selecting individual data elements (e.g., files). In doing so, the user can generate a group of desired items to be included in a group (e.g., collection, stack). While the disclosed aspects are directed toward the use of a dynamic “list,” it is to be appreciated that techniques included within the subject invention can be employed to generate any container known in the art. For example, the subject invention can be employed to generate a conventional “folder” whereby copies of the data elements are housed within the folder in contrast to a “list” whereby the list employs a dynamic link to access specific data elements associated therewith.

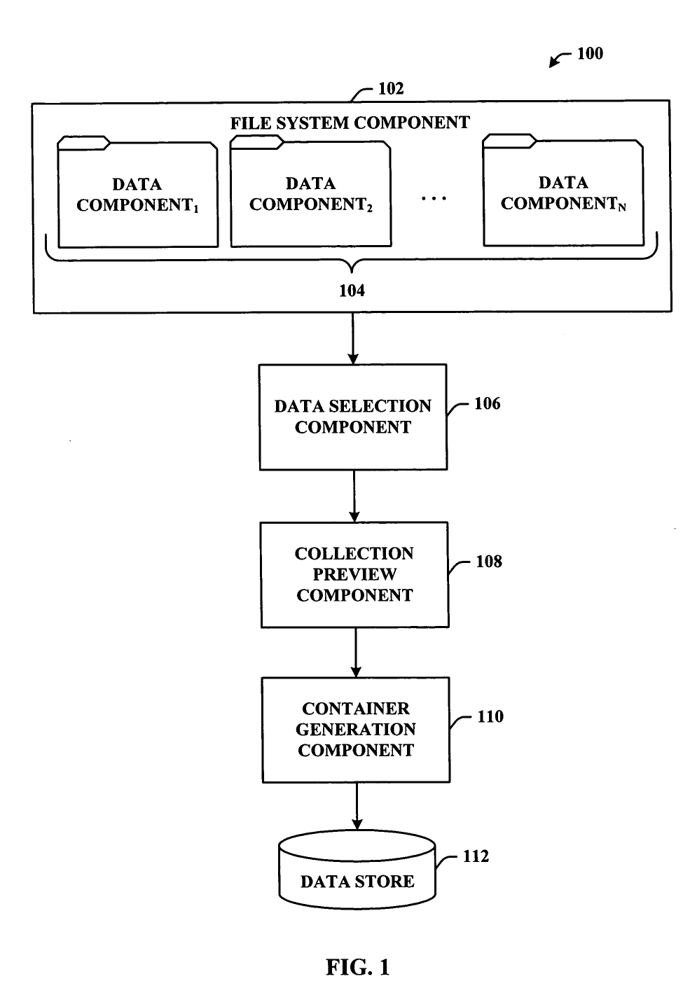

Referring now to FIG. 1, there is illustrated a schematic representation of an aspect of a system 100 that facilitates organization and compilation of a group or container (e.g., list, folder) in accordance with the subject invention. Generally, the system 100 can include a file system component 102 having data component(s) 104 included therein. The system 100 can also include a data selection component 106, collection preview component 108, a container generation component 110 and an optional data store component 112.

The file system component 102 can include N data components, where N is an integer. The data components can be referred to collectively or individually as data components 104 as illustrated. In accordance with aspect(s) of the invention, data component(s) 104 can include any type of electronic item, record, file, document, link, email, uniform resource locator (URL) or the like. By way of example, the data component 104 can be a file which represents a word processing document. In an alternate aspect, the data component 104 can be a link or hyperlink which points or links to a remotely stored data file. Those skilled in the art will appreciate that the file system component 102 can include any number of data components 104 of the same or different types.

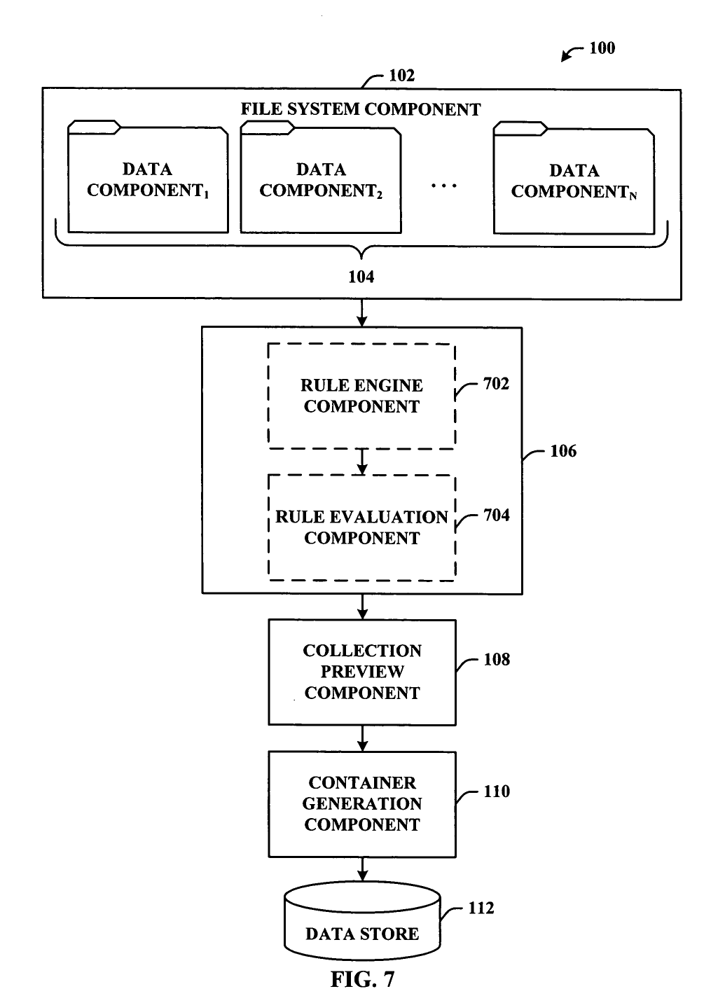

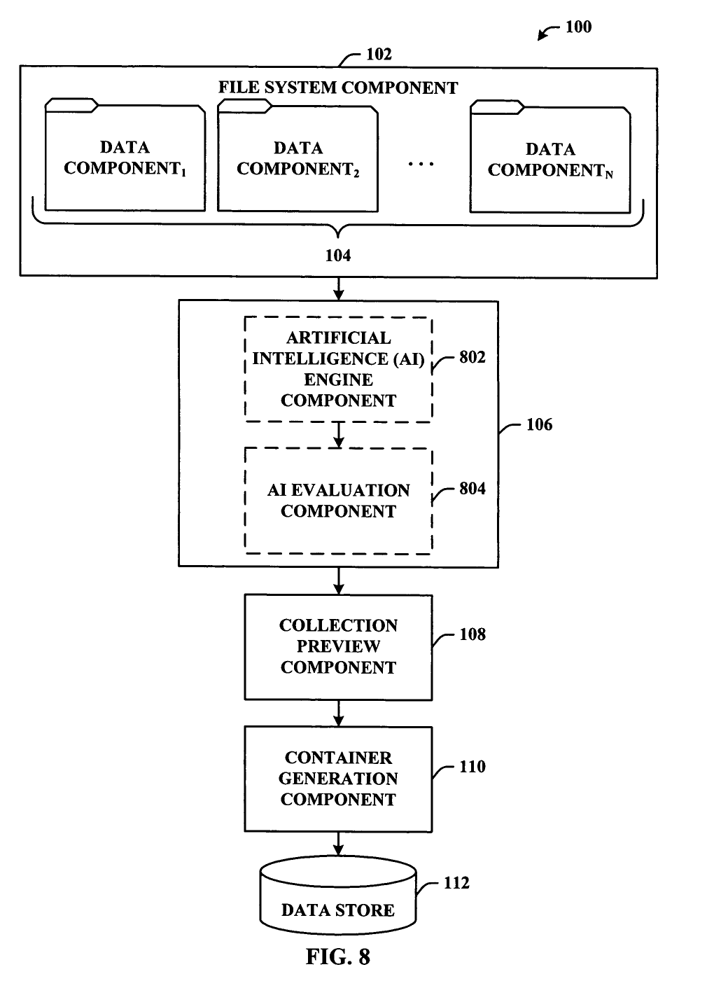

The data selection component 106 facilitates selection of items within a file system or other electronically accessible store. It is to be understood that any suitable method of selection can be employed in accordance with the claimed invention. Further, the data selection component 106 can be configured to accomplish manual or automatic selection of the desired data components 104. With respect to manual selection, in one aspect, a mouse or other pointing device (e.g., trackball, pointing stick, touchpad) can be employed to effect a selection of files. In another aspect, voice recognition or the like can be employed to effect the selection. In alternative aspects and by way of further example, the selection component 106 can be configured with a decision-making mechanism in the form of a rule engine whereby a rule can be applied to the file system component 102 thus selecting a subset of data components 104. Additionally, an artificial intelligence (AI) component can be employed individually or in combination with other evaluation schemes in order to effect selection based on an inference of a user intention with respect to the contents of a file system. These alternative aspects will be described in greater detail with respect to FIGS. 7 and 8 infra.

The collection preview component 108 can facilitate display of data components 104 as they are selected via a desktop operating system user interface (UI). In other words, collection preview component 108 can include a graphical user interface (GUI) capable of dynamically displaying a visual representation of the compilation of data components 104 as they are selected by the data selection component 106.

The container generation component 110 can—through any desired triggering mechanism (e.g., a single click or button press)—automatically generate retention of a collection in a data store 112 or any other memory device (not shown). This retention can be in the form of a container (e.g., list, folder, query). It is to be understood that a container can be any compilation of data components 104 known in the art. For example, a container can include, but is not intended to be limited to, a list, folder, directory or the like. The container generation component 110 can be suitably configured to either manually or automatically generate a container which represents the selected data components 104 (e.g., collection). The container generation component 104 can be manually instructed by a user that a selection is complete thereby prompting the generation of a container. It is to be appreciated that a user can employ any known technique to prompt the generation of the container. For instance, a user can utilize a keystroke, pointing device button, voice recognition or the like to prompt the generation.

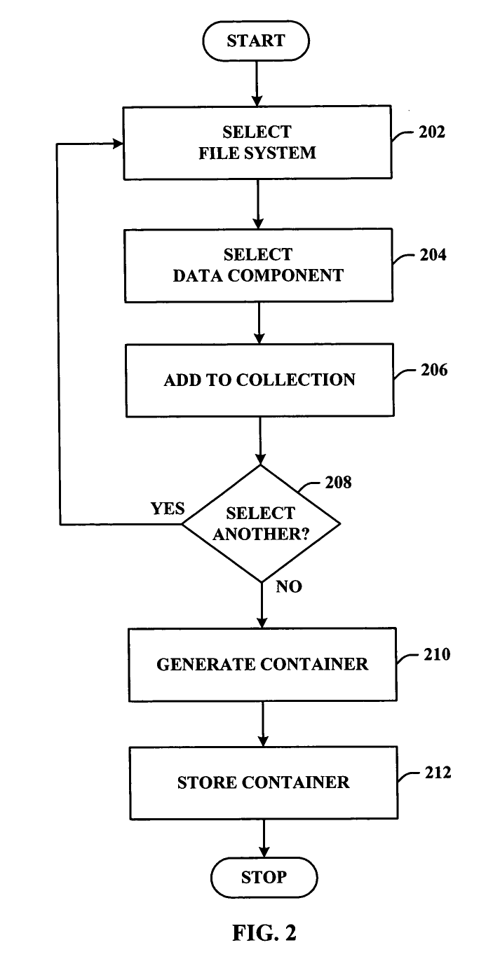

Referring now to FIG. 2, there is illustrated a flowchart in accordance with an aspect of the with the subject invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the subject invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Referring to FIG. 2, at 202, a file system or data store is selected. Next, at 204 the desired data components can be selected to initiate the compilation of a collection or stack. As previously noted, manual and/or automatic techniques can be employed to effectuate the selection(s) without departing from the scope and functionality of the claimed invention. Upon selection, and at 206, the selected data components can be added to a collection or stack. As described supra, it is to be appreciated that a UI can be employed that provides a visualization of the aggregation of data components upon selection.

At 208, the system can prompt to determine if another data component is desired. If an additional data component is desired, the system returns to 202 whereby the additional data component can be selected. It is contemplated that, as illustrated, the system can be configured to enable a user to select additional data components from an alternate file system location by returning to 202. In other words, in accordance with the subject system/methodology, it is contemplated that a collection can include data components that reside in multiple locations (e.g., disparate file systems).

If at 208 another data component is not desired, the system can proceed to create a collection at 210 whereby a container is generated once selection is complete. Finally, in accordance with a prompt, the container can be stored at 212. As described supra, it is to be understood that any method of prompting the system known in the art can be employed to effect persistence of the container.

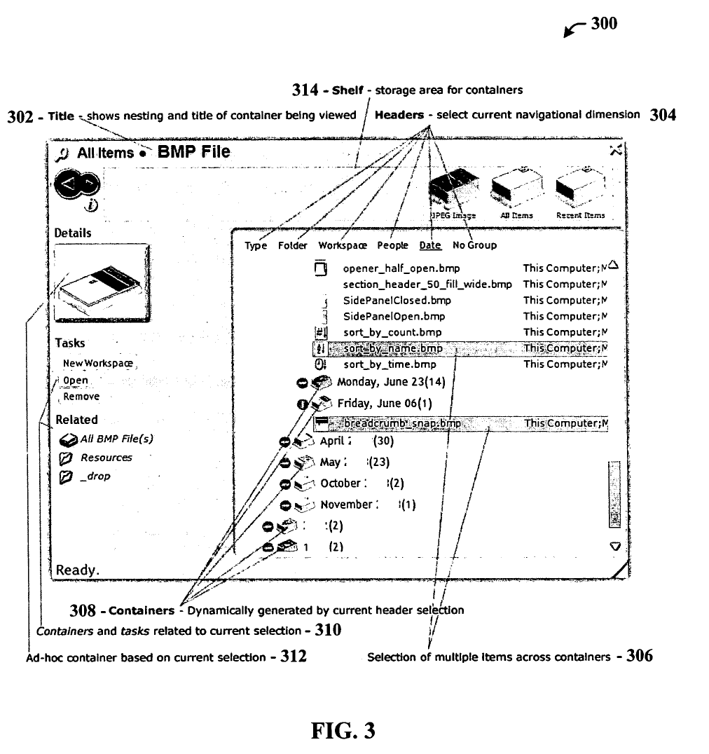

FIG. 3 illustrates an exemplary UI 300 that facilitates employing an aspect of the subject invention. As illustrated, a title 302 is illustrated that identifies a particular nesting and title of a container viewed. Headers 304 provide navigational dimensions within the UI. By way of example, a chronological sort can be provided (e.g., via Date) as shown. Other navigational dimensions can be provided including, but not limited to by Type, Folder, Workspace, People, No Group, or the like.

Selection of desired data components can be effected as described supra. It has been contemplated, that as indicated at 306, selection of multiple items across containers can be effected in accordance with the subject invention. It should be noted that the GUI of FIG. 3 can provide a thumbnail or other representation of containers 308 that are dynamically generated by the current header selection. As well, representations of containers and tasks 310 related to the current selection can be provided by the GUI 300.

An ad hoc container 312 which represents the current selection can be provided. It should be understood that the representation of containers (e.g., 308, 312) in accordance with the subject invention can be arranged in any desired manner. For example, and as illustrated in FIG. 3, the ad hoc container representation 312 can be provided in the form of a thumbnail image which depicts a stack of data elements having the most recent document displayed on the top of the stack. Alternate representations can be utilized without departing from the scope and functionality of the claimed invention. Once persisted, the thumbnail images of the container(s) can be displayed on a shelf 314 which can be a representation of a storage area for the container(s).

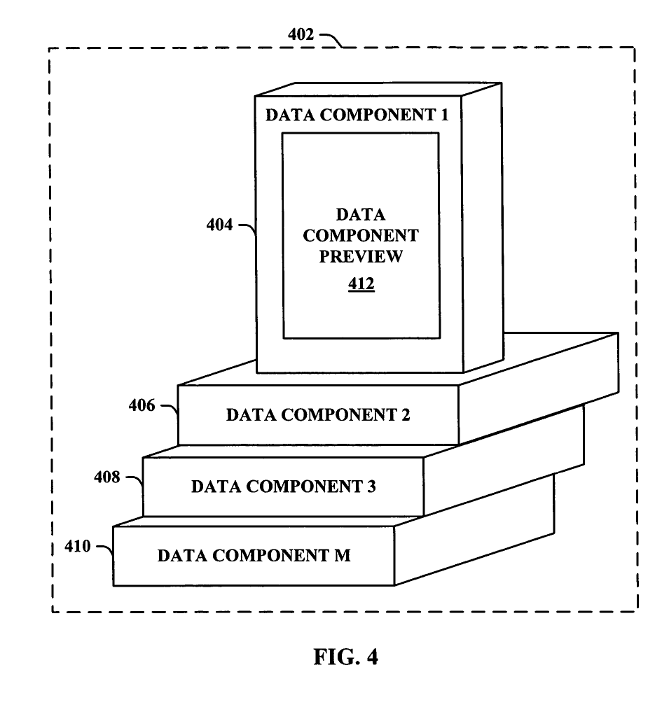

Turning now to FIG. 4, an alternate representation of an ad hoc container representation 402 is shown. The exemplary representation of FIG. 4 shows M data components (404, 406, 408, 410) where M is an integer. Although only four data components (404, 406, 408, 410) are illustrated in the stack of container 402, it will be understood that a collection or container can have any number of items desired. Continuing with the example, the items shown in the exemplary stack are depicted in chronological order. In other words, data component M (410) represents the first selected while data component 1 (404) represents the most recently selected item.

In accordance with an aspect, the subject invention enables interactively and dynamically viewing of the items in a stack or container. In other words and with reference to FIG. 4, one aspect can provide for displaying a preview or thumbnail 412 of a selected document within a stack. Those skilled in the art will appreciate that any suitable technique known for selecting items in the container 402 can be employed in accordance with the claimed invention. By way of example, a user can utilize a mouse or other pointing device to select from the items in a stack. Once selected, the chosen item can be reconfigured to provide for a graphical preview.

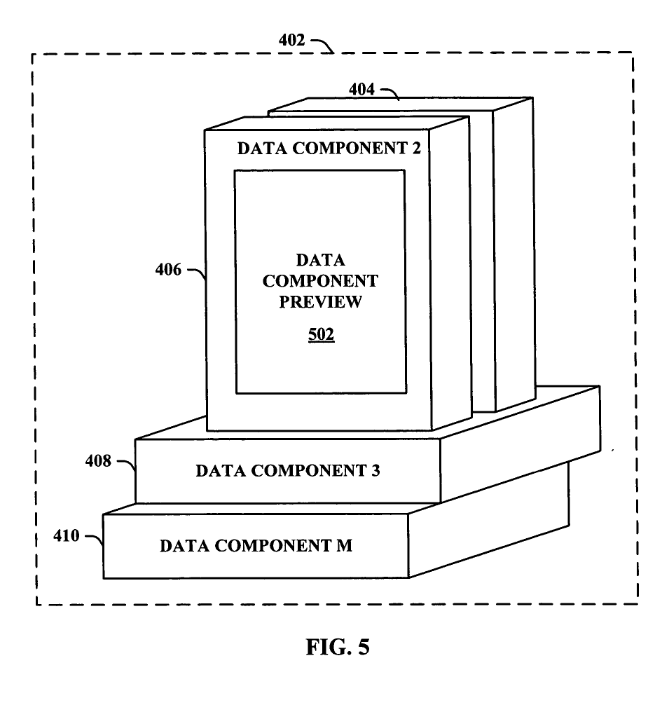

As shown in FIG. 4, if the data component 1 (404) is selected, the GUI can be configured to display a thumbnail representation 412 of the data component in a vertical fashion. With reference now to FIG. 5, if a user desires to select data component 2 (406), the system can be configured to provide a thumbnail representation 502 of data component 2 (406) in the foreground whereby data component 1 (404) can be repositioned in the background as shown.

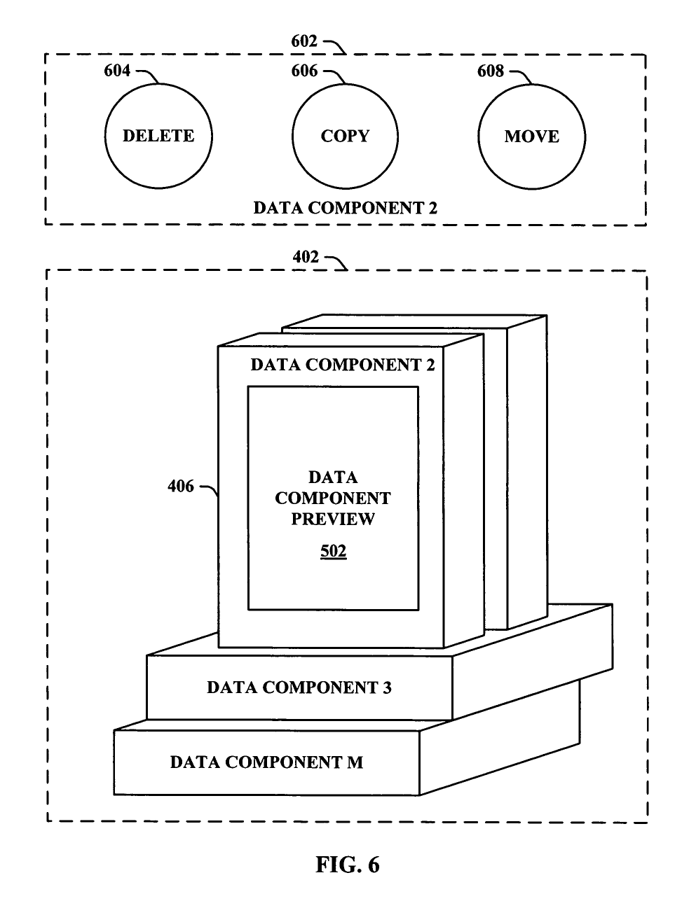

Another novel aspect of the subject invention provides for a mechanism for manipulating the items included within a stack, container and/or collection. More particularly, the invention provides for an interactive preview mechanism to effect modification and/or refinement operations with respect to the items contained within a set (e.g., collection, stack). For example, a manipulation and/or refinement operation can include, but is not limited to, delete, copy, move, open, send to, etc. Referring again to the example, FIG. 6 illustrates a selection halo 602 whereby a user can select from various options (e.g., 604, 606, 608) in order to manipulate a particular item within a stack (e.g., data component 2). As shown, the selection halo 602 can be associated with the currently displayed thumbnail image (e.g., data component 2). One exemplary technique to effect a selection halo can be to hover over or point at the desired item within a stack with a pointing device. Those skilled in the art will appreciate that any alternative methods of selecting and/or prompting manipulation can be used and are contemplated to be included within the claimed invention. For instance, an “undo” option or the like can be employed to provide a user with a mechanism to correct inadvertent or unwanted selections.

With reference now to FIG. 7, an alternate aspect of system 100 is depicted. More particularly, the selection component 106 generally includes a rule engine component 702 and a rule evaluation component 704. In accordance with this alternate aspect, an implementation scheme (e.g., rule) can be applied to identify a selection. It will be appreciated that the rule-based implementation can automatically and/or dynamically select data component(s) included within a collection and employ a predefined and/or programmed rule(s) based upon any desired criteria (e.g., file type, file size, hardware characteristics). In an exemplary scenario, a user can establish a rule that can implement selection of a preferred type of file (e.g., music). For instance, a rule can be constructed to select all music files from a targeted data store or source location. Accordingly, a collection can be constructed, previewed and/or manipulated as desired. Finally, a container can be generated and stored in a desired location and/or device. It will be appreciated that any of the specifications utilized in accordance with the subject invention can be programmed into a rule-based implementation scheme.

Continuing with the example and again with reference to FIG. 7, a more detailed schematic view of the selection component 106 is shown. As illustrated, data selection component 106 can generally include a rule engine component 702 and a rule evaluation component 704. As will later be described, an optional artificial intelligence component (not shown) can be used together with, or in place of, the rule-based components (e.g., 702, 704) to automatically infer a rule or set of rules.

In the exemplary aspect of FIG. 7, the rule engine component 702 can be programmed or configured in accordance with a user-defined preference. As well, a rule can be established in accordance with a specific hardware configuration or in accordance with a software application. For example, a rule can be constructed in accordance with specific memory capacity and/or display of a device. In other words, a rule can be established to take into consideration the specific limitations of a hardware device (e.g., display mechanism, memory capacity). The rule evaluation component 704 can facilitate application of the rule. Based upon the output of the rule evaluation component 704, the collection preview component 108 can dynamically generate a preview of the stack or collection as discussed supra.

It is to be appreciated that the rule evaluation component 704 can be used once to populate the list at the time of its creation (or user-initiated modification). Such a list can be referred to as a static collection of items. Alternatively, the rule itself can become a part of the list and thereby evaluated every time the list is accessed. This rule-incorporated situation, in turn, can be referred to as a dynamic collection (e.g., list). A mixed-type list is also possible, whereby some items are derived dynamically from a rule, while others are added to the list explicitly.

A schematic diagram of another alternative aspect of the subject invention is illustrated in FIG. 8. Generally, FIG. 8 illustrates the system 100 including components having similar functionality as those discussed previously with reference to FIG. 1. However, the selection component 106 of this aspect includes an artificial intelligence (AI) engine component 802 and an AI evaluation component 804.

In accordance with this aspect, the optional AI engine and evaluation components 802, 804 can facilitate automatically performing various aspects (e.g., data component selection, collection compilation, container location) of the subject invention as described herein. The AI component can optionally include an inference component that can further enhance automated aspects of the AI component utilizing, in part, inference based schemes to facilitate inferring intended actions to be performed at a given time and/or state. The AI-based aspects of the invention can be effected via any suitable machine-learning based technique and/or statistical-based techniques and/or probabilistic-based techniques.

In the alternate aspect, as further illustrated by FIG. 8, the subject invention (e.g., in connection with selecting data components) can optionally employ various artificial intelligence based schemes for automatically carrying out various aspects thereof. Specifically, artificial intelligence engine and evaluation components 802, 804 can optionally be provided to implement aspects of the subject invention based upon artificial intelligence processes (e.g., confidence, inference). For example, a process for determining the members of a collection (e.g., data component(s)) based upon contents of a data store and target device type can be facilitated via an automatic classifier system and process. Further, the optional artificial intelligence engine and evaluation components 802, 804 can be employed to facilitate an automated process of collection in accordance with hardware specifications whereby data files corresponding to a specific type can be associated to a particular container (e.g., list).

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of data component selection, for example, attributes can be file types or other data-specific attributes derived from the file types and/or contents, and the classes can be categories or areas of interest.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's can be configured via a learning or training phase within a classifier constructor and feature selection module. In other words, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated and are intended to fall within the scope of the hereto appended claims.

Other implementations of AI could include alternative aspects whereby, based upon a learned or predicted user intention, the system can prompt for additional inclusions into a selection. Likewise, an optional AI component could prompt a user to delete an item from a collection. Moreover, AI can be used to search for commonality of files or other data components.

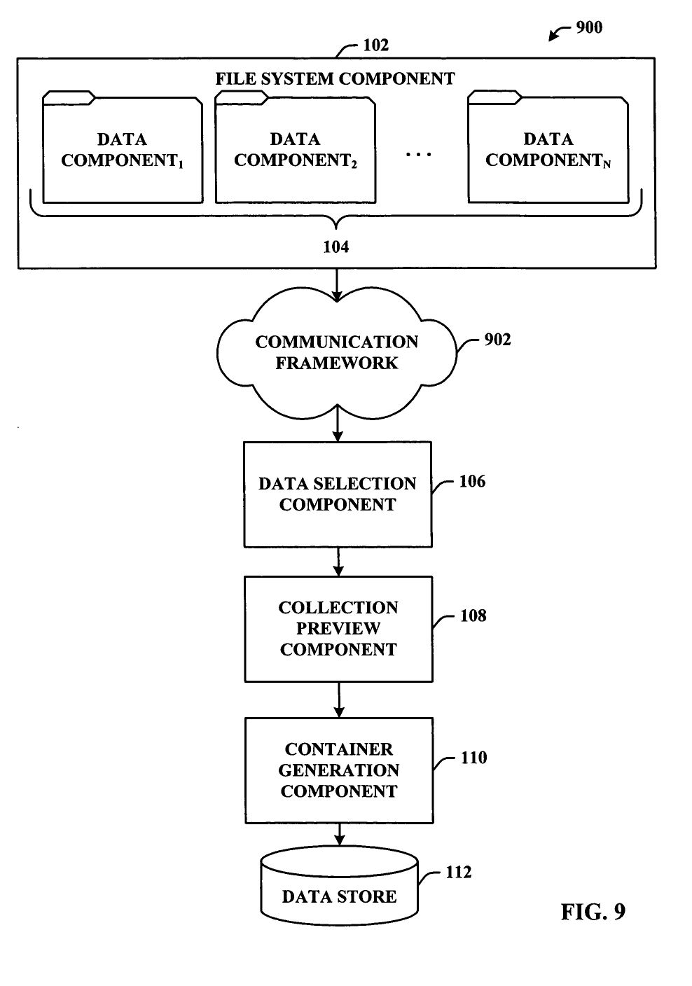

Referring to FIG. 9, a schematic block diagram an exemplary computing environment is shown in accordance with an aspect of the subject invention. Specifically, the system 900 illustrated includes a file system component 102 having data components 104 contained therein. Further, the system 900 includes a data selection component 106, collection preview component 108, a container generation component 110 and an optional data store 112. These components can have the same functionality as discussed in detail supra. Additionally, the system 900 illustrated employs a communication framework 902 whereby the file system component 102 can be remote from the other system components (e.g., 106, 108, 110, 112).

In accordance with this aspect, it will be understood that the generated list (e.g., container) can likewise be remote from the source file system 102. By way of example, suppose a portable device (e.g., MP3-compatible player) houses the system components 106-112. It will be appreciated that a list could be persisted on the portable device whereby, the actual data can be accessed via wired or wireless mechanisms (e.g., communications framework 902). Communications framework 902 can employ any communications technique (wired and/or wireless) known in the art. For example, communications framework 902 can include, but is not limited to, Bluetooth™, Infrared (IR), Wi-FI, Ethernet, or the like.

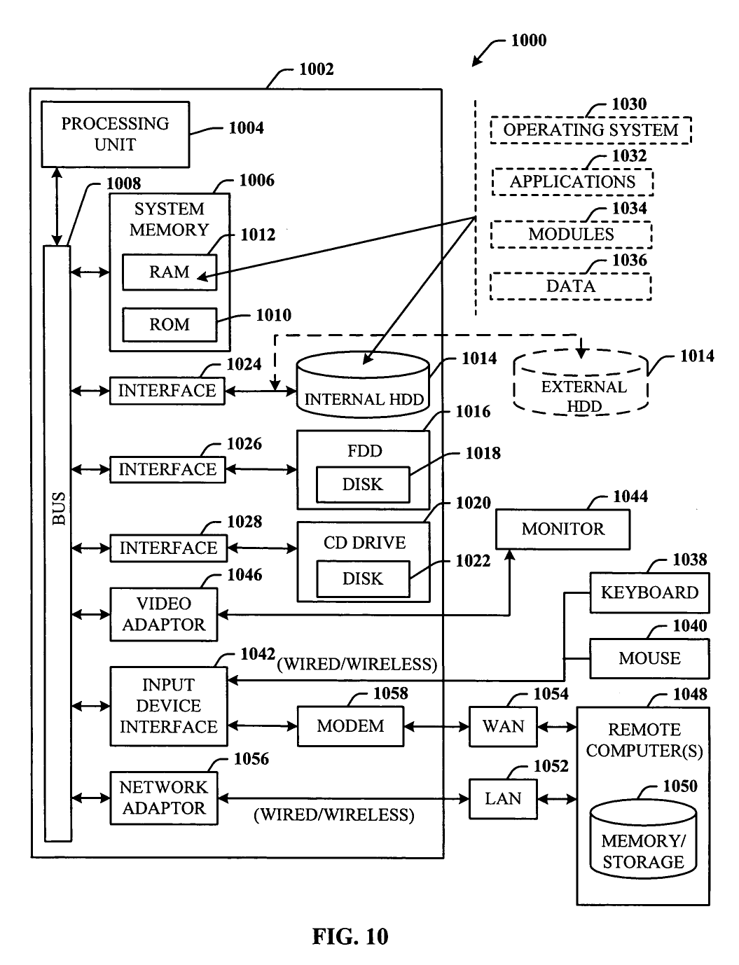

Referring now to FIG. 10, there is illustrated a block diagram of a computer operable to execute the disclosed architecture. In order to provide additional context for various aspects of the subject invention, FIG. 10 and the following discussion are intended to provide a brief, general description of a suitable computing environment 1000 in which the various aspects of the subject invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, there is illustrated an exemplary environment 1000 for implementing various aspects of the invention that includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the subject invention.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the subject invention can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056. When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

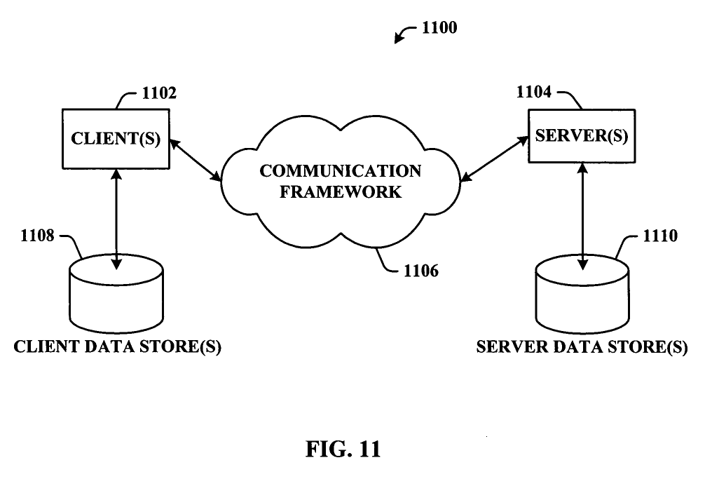

Referring now to FIG. 11, there is illustrated a schematic block diagram of an exemplary computing environment 1100 in accordance with the subject invention. The system 1100 includes one or more client(s) 1102. The client(s) 1102 can be hardware and/or software (e.g., threads, processes, computing devices). The client(s) 1102 can house cookie(s) and/or associated contextual information by employing the subject invention, for example. The system 1100 also includes one or more server(s) 1104. The server(s) 1104 can also be hardware and/or software (e.g., threads, processes, computing devices). The servers 1104 can house threads to perform transformations by employing the subject invention, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates creating a data container, the system comprising:
a selection component that facilitates compiling a collection associated with one or more data components; and
a container generation component that automatically generates a container that represents the collection.

2. The system of claim 1, further comprising a preview component that dynamically displays the collection as each of the one or more data components are compiled.

3. The system of claim 2, the container generation component automatically generates the container in response to a trigger.

4. The system of claim 1, at least one of the one or more data components is an electronic file.

5. The system of claim 1, at least one of the one or more data components is a link.

6. The system of claim 1, at least one of the one or more data components is a disparate container.

7. The system of claim 1, the container is a list having a link to each of the one or more data components.

8. The system of claim 1, the container is a folder that includes a copy of each of the one or more data components.

9. The system of claim 1, the container generation component automatically retains the container in a data store.

10. The system of claim 1, further comprising:
a rule engine component that automatically instantiates a rule that implements a predefined criteria; and
a rule evaluation component that applies the rule with respect to the one or more data components to instruct the selection component to dynamically select the one or more data components.

11. The system of claim 10, the rule engine component is located remotely from the view selection component.

12. The system of claim 1, the container generation component is remote from the one or more data components.

13. The system of claim 1, further comprising an artificial intelligence component that predicts a user intention as a function of historical user criteria.

14. The system of claim 13, the artificial intelligence component includes an inference component that facilitates automatic selection of the one or more data components as a function of the predicted user intention with respect to a characteristic.

15. The system of claim 14, the inference component employs a utility-based analyses in performing the automatic selection.

16. A desktop computing system that employs the system of claim 1.

17. A portable computing device that employs the system of claim 1.

18. The system of claim 1, further comprising an intelligence component that employs a statistical-based analysis to infer an action that a user desires to be automatically performed.

19. A computer readable medium having stored thereon the components of claim 1.

20. A method of organizing data, the method comprising:
selecting one or more data components within a file system;
assembling a collection from the selected one or more data components; and
automatically generating a container that represents the collection.

21. The method of claim 20, further comprising dynamically generating a preview of the collection as each of the one or more data components are assembled.

22. The method of claim 21, further comprising triggering the generation of the collection.

23. The method of claim 20, at least one of the one or more data components is a data file.

24. The method of claim 20, at least one of the one or more data components is a link.

25. The method of claim 20, at least one of the one or more data components is a disparate container.

26. The method of claim 20, the act of automatically generating the container further comprises linking the collection to each of the one or more selected data components.

27. The method of claim 20, further comprising automatically storing the container in a data store.

28. The method of claim 20, further comprising applying a rule that dynamically determines the selection of the one or more data components.

29. The method of claim 20, further comprising predicting a user intention that determines the selection of the one or more data components.

30. A computer readable medium having stored thereon computer executable instructions for carrying out the method of claim 20.

31. A system that facilitates organizing data, the system comprising:
means for selecting a subset of a file system, the subset having one or more data elements;
means for dynamically previewing the selected subset of the file system; and
means for automatically generating a container associated with the selected subset of the file system.

32. The system of claim 31, the means for selecting is a rule-based operation.

33. The system of claim 31, the means for selecting is an artificial intelligence operation.

34. The system of claim 31, further comprising means for automatically storing the container in a data store.

35. A system that facilitates managing data, the system comprising:
a selection component that generates a stack, the stack includes a plurality of data components;
a preview component that dynamically displays the stack as each of the plurality of data components are added to the stack; and
a container generation component that automatically generates a container that represents the stack.

36. The system of claim 35, the container is a list that points to each of the plurality of data components.

37. The system of claim 35, the container is a folder that includes a copy of each of the plurality of data components.

38. The system of claim 35, further comprising:
a rule engine component that automatically instantiates a rule that implements a predefined criteria; and
a rule evaluation component that applies the rule with respect to the one or more data components to instruct the selection component to dynamically select the one or more data components.

39. The system of claim 35, the artificial intelligence component includes an inference component that facilitates automatic selection of the one or more data components as a function of the predicted user intention with respect to a characteristic.

40. A computer readable medium having stored thereon computer executable instructions for carrying out the system of claim 35.
